(19) United States
(12) Patent Application Publication
(10) Pub. No.: US 2004/0099714 A1
(43) Pub. Date: May 27, 2004

(54) Reduced weldment pre-heat technique for nickel based superalloys

(76) Inventors: Thaddeus J. Strusinski, Easley, SC (US); Jeffry Killough, Houston, TX (US); David Vargas Leal, Houston, TX (US); Paul A. Wilson, Pearland, TX (US); Michael J. Butler, Seabrook, TX (US); Daniel Salinas, Channelview, TX (US); M. Lee Blackwell, Conroe, TX (US)

Correspondence Address: NIXON & VANDERHYE P.C., 8th Floor, 1100 North Glebe Rd., Arlington, VA, 22201-4714, US

(21) Appl. No.: 10/303,772

(22) Filed: Nov. 26, 2002

(51) Int. Cl. B23K 31/00

(52) U.S. Cl. 228/232; 228/231

(57) ABSTRACT

Method for forming a weldment in a nickel based alloy substrate comprising subjecting the substrate prior to welding to a pre-heating step at an elevated temperature which is above ambient temperature and less than an aging temperature of the substrate.

The present invention relates generally to welding of nickel based superalloys. More specifically, the invention provides a method for producing robust weldments for nickel base superalloys employing a pre-heat technique under defined conditions.

### BACKGROUND OF THE INVENTION

It is known that welding of nickel based superalloys is challenging due to component geometries and characteristics of precipitation strengthened nickel based superalloy base metal and filler wire. Precipitation strengthened nickel based superalloy is subject to strain age cracking, and its high strength characteristics make it susceptible to solidification shrinkage and hot tears. As a result, gas turbine hardware which is typically made of precipitation strengthened nickel based superalloys, has proven difficult to weld.

Gas turbine hardware castings all need to have welds applied in order to complete the component. Ideally, the regions where welds need to be made are designed into locations that are lower stress areas, and provide easy access to perform the welds and inspections. However, due to the size of the latest designs of land based industrial gas turbine components, when welded in a production environment they do not respond the same as small turbine components or coupons.

Ideally, the optimum weld is performed with a base metal equivalent superalloy filler wire. However, these highly alloyed materials are prone to solidification shrinkage, hot tears and cracking during the welding process. In addition, strain age cracking due to gamma prime precipitation occurs when the component is post-weld vacuum heat-treated. Weldment cracking occurs as the weld is made, as well as when the component cools down to room temperature, and during the formal post weld vacuum furnace heat-treatment.

A need exists for a way of producing a weldment on gamma prime strengthened nickel based superalloy gas turbine components in which melting of the base metal near the weldment during welding is reduced, and in which the propensity of solidification shrinkage and hot tears is minimized. The present invention seeks to fill that need.

### BRIEF DESCRIPTION OF THE INVENTION

It has now been discovered that it is possible to form robust weldments for nickel base superalloys by use of a pre-heat weldment technique using defined conditions. The method is particularly adapted for land based industrial gas turbine components made of gamma prime strengthened nickel based superalloys, and essentially eliminates the melting and reduces cracking therein.

According one aspect, there is provided a method for forming a weldment in a substrate comprising subjecting said substrate to pre-heating at an elevated temperature which is above ambient but less than the aging temperature of the alloy prior to welding. Typically, the pre-heating carried out in an inert atmosphere, for example in an inert gas purged container. Typically the pre-heat is carried out at a temperature which is below the ductile temperature of the alloy and less than the incipient melting temperature. More usually the substrate is subjected to pre-heating in an inert atmosphere, for example in an inert gas purged container, at an elevated temperature which is above ambient but less than the aging temperature and less than the ductile temperature of the alloy.

The method of the invention may be used during manual or automated welds on precipitation strengthened nickel based superalloy gas turbine components.

### BRIEF DESCRIPTION OF THE DRAWINGS

FIG. 1 is a graph of temperature versus time showing a thermal cycle of weldment and including the pre-heat treatment of the present invention;

FIG. 2 shows a Design Of Experiment (DOE) result depicting a plot of Fluorescent Penetrant Inspection (FPI) indication decrease with the use of the an improvement when coupled with a weldment post-heat stress relief process;

FIG. 3 is an FPI result of an actual hot gas path component during qualifications of welders, showing the bottom of the weld with no cracks present (the picture shows “clean” results under the black light);

FIG. 4 is another FPI result of an actual hot gas path component during qualifications of welders, showing the view of the top of the weld (there re are no cracks present and the picture shows “clean” results under the black light);

FIG. 5 is a metallographic result of an actual hot gas path component during qualifications of welders, in which the cross sectional view shows the termination of the weld and base metal interface, having no defects present at 500× magnification; and

FIG. 6 is another metallographic result of an actual hot gas path component during qualifications of welders, wherein the cross sectional view shows the termination of the weld and base metal interface, having no defects present at 500× magnification.

### DETAILED DESCRIPTION OF THE INVENTION

Referring to the drawings, FIG. 1 shows a typical welding thermal cycle. A pre-heat stage according to the present invention is shown at A. The pre-heat stage A is at a temperature which is above ambient F but which is substantially less than the aging temperature (shown as a horizontal dotted line G).

Typically, the pre-heat temperature of the pre-heat stage A is in the range of 700 to 1500° F., more usually 800-1200° F.

As shown in FIG. 1, the temperature is increased from ambient temperature (F) to the pre-heat temperature over a time period of about 5-20 min, more usually 10-15 min.

Once the pre-heat temperature has been reached, the temperature is maintained at that level for a period of time prior to welding. Typically, the period of time for the pre-heat is 2-12 min, more usually 5-10 min.

The pre-heat stage A is typically carried out in an inert atmosphere. Typically, the insert gas is argon, although other insert gases may be employed e.g. helium or nitrogen. Vacuum may also be employed as an alternative.

Upon completion of the welding stage B, the temperature falls to stage C which is the beginning of the post-heat stage D, E. The temperature at stage C is typically in the range of 700-1500° F., and is normally held for a period of time approximating 5-30 min.

Post-heating stage D, E is initiated by heating to raise the temperature rapidly to a temperature above the aging temperature but below the incipient melting temperature. The temperature then falls to ambient at stage E. The temperature range D is typically 1700-2100° F. The time range E is typically 5-30 min.

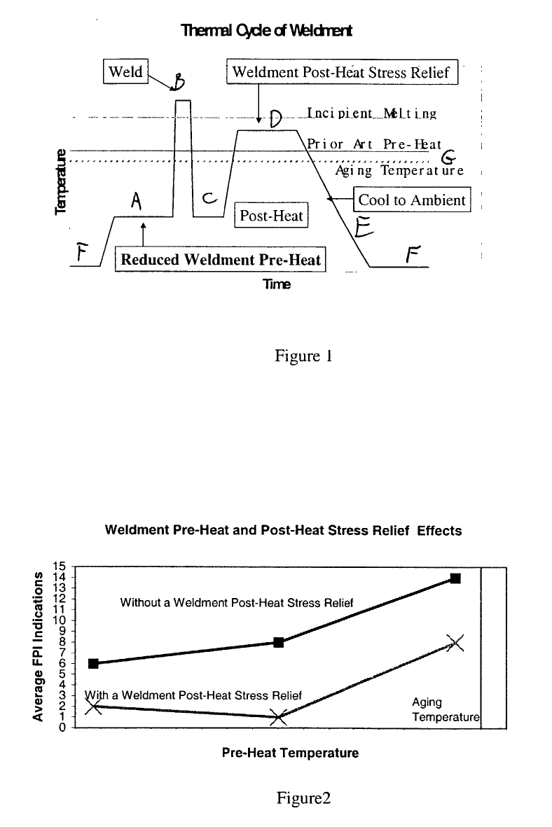

FIG. 2 shows a Design Of Experiment (DOE) result showing a plot with FPI indications that decrease with the use of the present technique. Particularly improved results are observed when the technique is coupled with a weldment post-heat stress relief process D, E as discussed above in relation to FIG. 1. Once the weld is completed, the post-heat temperature in the inert gas purged container is further elevated, to provide a localized post-heat stress relief of the weldment that minimizes the cracking induced by inherent weld stresses in a highly constrained geometry, and acts to initially precipitate the gamma prime particles prior to the cool down to ambient temperature, thereby minimizing the propensity to strain age crack when the component is formally vacuum furnace heat treated.

The improvements are seen in the fewer number of cracks present after a post-weld vacuum heat treatment observable via Fluorescent Penetrant Inspection (FPI). Fluorescent Penetrant Inspection uses a liquid that will penetrate fissures in a material and when a black light is shined on the surface the fissures or cracks (if any) will glow. The number of FPI indications are what is plotted on the vertical axis, and the horizontal axis presents the pre-heat.

The following items were used for actual production first piece qualifications (FPQ), pilot lot qualifications (PLQ) and welder qualifications for gamma prime strengthened nickel based superalloy gas turbine hardware produced by GE-Power Systems. FPQ consists of three weldments made with all processing steps required for the production cycle, having met all Fluorescent Penetrant Inspection (FPI) and metallography criteria. PLQ consists of one production part, randomly selected during the production effort, meeting all FPI and metallography criteria. Welder Qualification consists of three weldments made with all processing steps required for the production cycle, having met all FPI and metallography criteria.

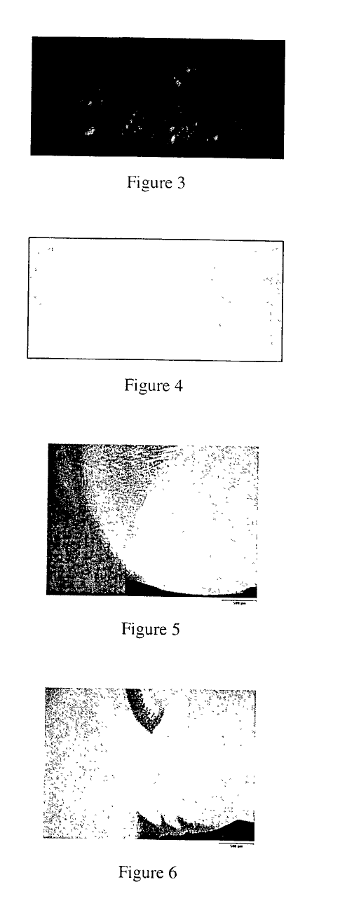

FIG. 3 depicts a weldment FPI result of the root pass after a formal post-weld vacuum heat treatment. Thus, FIG. 3 is an FPI result of an actual hot gas path component during qualifications of welders. This figure is the view of the bottom of the weld. There are no cracks present, which is good. Thus, the figure shows “clean” results under the black light.

FIG. 4 is another FPI result of an actual hot gas path component during qualifications of welders. This figure is the view of the top of the weld. There are no cracks present (which is good). Thus, the figure shows “clean” results under the black light.

FIG. 5 is a metallographic result of an actual hot gas path component during qualifications of welders. The cross sectional view shows the termination of the weld and base metal interface, having no defects present at 500× magnification.

FIG. 6 presents a further metallographic evaluation of gamma prime strengthened nickel based superalloy base metal.

The method of the invention is useful for gamma prime strengthened nickel based superalloy components, such as nozzles, vanes, buckets and blades, particularly when coupled with a weldment post-heat stress relief stage. The method is also adapted for casting repairs required from service related damage.

### EXAMPLES

Example 1

The following items were used for actual production first piece qualifications (FPQ), pilot lot qualifications (PLQ) and welder qualifications for gamma prime strengthened nickel based superalloy gas turbine hardware produced by GE-Power Systems.

FPQ consists of three weldments made with all processing steps required for the production cycle, having met all Fluorescent Penetrant Inspection (FPI) and metallography criteria. PLQ consists of one production part, randomly selected during the production effort, meeting all FPI and metallography criteria. Welder Qualification consists of three weldments made with all processing steps required for the production cycle, having met all FPI and metallography criteria.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. Method for forming a weldment in a metal substrate comprising subjecting said substrate prior to welding to a pre-heating step at an elevated temperature which is above ambient temperature and less than an aging temperature of the metal substrate.

2. Method according to claim 1 wherein said metal substrate comprises a nickel based superalloy.

3. Method according to claim 2, wherein said elevated temperature is in the range of 700-1500° F.

4. Method according to claim 2, wherein said elevated temperature is in the range of 800-1200° F.

5. Method according to claim 2, wherein said pre-heating step is carried out for 5-20 min.

6. Method according to claim 2, wherein said pre-heating step is carried out for 10-15 min.

7. Method according to claim 2, wherein said pre-heat stage is carried out in an inert atmosphere.

8. Method according to claim 7, wherein said inert atmosphere is argon or nitrogen.

9. Method according to claim 2, wherein said pre-heat stage is carried out under vacuum.

10. Method according to claim 2, wherein subsequent to welding said substrate is subjected to a post-heat stage at a temperature of 1700-2100° F.

11. Method according to claim 2, wherein subsequent to welding said substrate is subjected to a post-heat stage at a temperature of 1850-2050° F.

12. Method according to claim 10, wherein said post-heat stage is carried out for a period of 5-30 min.

13. Method according to claim 10, wherein subsequent to said post-heat stage said substrate is cooled.

14. Method according to claim 1, wherein said substrate is a component for a nuclear reactor.

15. A substrate containing a weldment produced according to the process of claim 13.
